(19) United States
(12) Patent Application Publication
(10) Pub. No.: US 2021/0064137 A1
(43) Pub. Date: Mar. 4, 2021

(54) ELECTRONIC DEVICE INCLUDING SENSOR DRIVEN HAPTIC ACTUATOR AND RELATED METHODS

(71) Applicant: Apple Inc., Cupertino, CA (US)

(72) Inventors: Kathryn K. WOPAT, San Francisco, CA (US); Hari Vasudevan, Bangalore (IN)

(21) Appl. No.: 16/989,489

(22) Filed: Aug. 10, 2020

Related U.S. Application Data
(60) Provisional application No. 62/893,950, filed on Aug. 30, 2019.

(51) Int. Cl. G06F 3/01

(52) U.S. Cl. CPC G06F 3/016

(57) ABSTRACT

An electronic device may include a haptic actuator that includes a field member including at least one permanent magnet, and at least one coil configured to cause relative movement with the field member. The electronic device may also include at least one inductance sensor configured to sense relative movement between the at least one coil and field member and a processor configured to drive the at least one coil based upon the at least one inductance sensor.

### RELATED APPLICATION

The present application claims the priority benefit of provisional application Ser. No. 62/893,950 filed on Aug. 30, 2019, the entire contents of which are herein incorporated by reference.

### TECHNICAL FIELD

The present disclosure relates to the field of electronics, and, more particularly, to the field of haptics.

### BACKGROUND

Haptic technology is becoming a more popular way of conveying information to a user. Haptic technology, which may simply be referred to as haptics, is a tactile feedback based technology that stimulates a user's sense of touch by imparting relative amounts of force to the user.

A haptic device or haptic actuator is an example of a device that provides the tactile feedback to the user. In particular, the haptic device or actuator may apply relative amounts of force to a user through actuation of a mass that is part of the haptic device. Through various forms of tactile feedback, for example, generated relatively long and short bursts of force or vibrations, information may be conveyed to the user.

### SUMMARY

An electronic device may include a haptic actuator that includes a field member including at least one permanent magnet, and at least one coil configured to cause relative movement with the field member. The electronic device may include at least one inductance sensor configured to sense relative movement between the at least one coil and field member and a processor configured to drive the at least one coil based upon the at least one inductance sensor.

The processor may be configured to drive the at least one coil based upon a sensed voltage and a sensed current of the at least one coil. The processor may be configured to drive the at least one coil based upon an inductance-to-displacement look-up table, for example.

The processor may be configured to drive the at least one coil based upon a displacement-to-voltage feedforward loop. The processor may be configured to drive the at least one coil based upon a reference displacement, for example.

The processor may be configured to drive the at least one coil based upon a reference tone, for example. The electronic device may also include an output amplifier coupled between the processor and the at least one coil.

A related method aspect is directed to a method of driving at least one coil of a haptic actuator that includes a field member including at least one permanent magnet, and at least one coil configured to cause relative movement with the field member. The method may include using at least one inductance sensor to sense relative movement between the at least one coil and field member and using a processor to drive the at least one coil based upon the at least one inductance sensor.

Another aspect is directed to an electronic device that may include a haptic actuator that includes a field member including at least one permanent magnet, and at least one coil configured to cause relative movement with the field member. The electronic device may include at least one capacitive sensor configured to sense relative movement between the at least one coil and field member and a processor configured to drive the at least one coil based upon the at least one capacitive sensor.

### BRIEF DESCRIPTION OF THE DRAWINGS

FIG. 1 is a schematic diagram of an electronic device in accordance with an embodiment.

FIG. 2 is a more detailed schematic diagram of portions of the electronic device of FIG. 1.

FIG. 3 is a schematic diagram of portion of an electronic device in accordance with another embodiment.

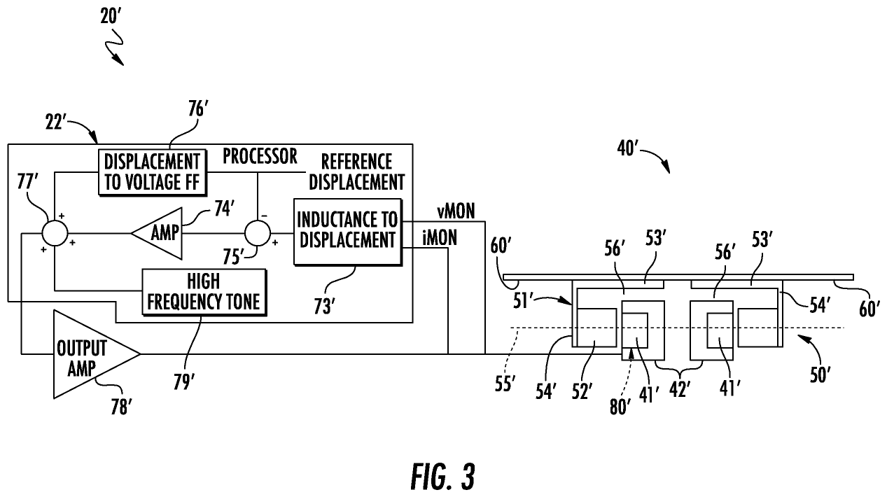

FIG. 4 is a schematic diagram of portion of an electronic device in accordance with another embodiment.

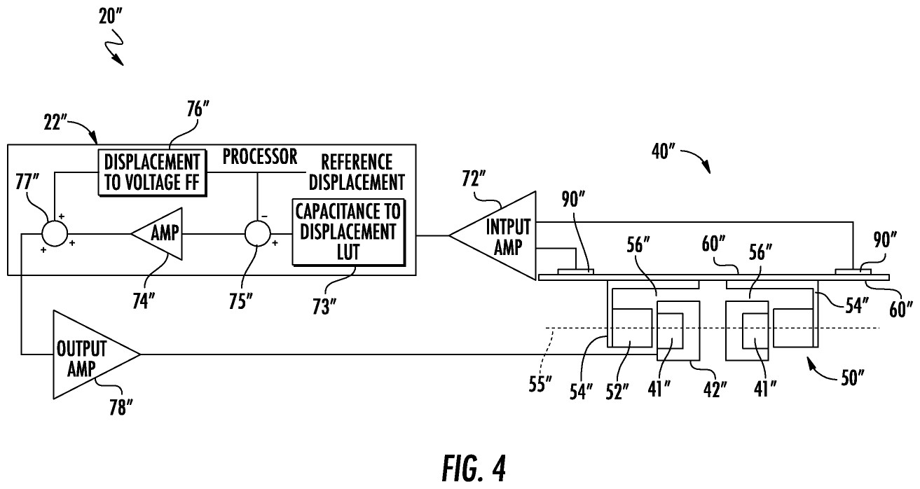

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime notation is used to indicate similar elements in alternative embodiments.

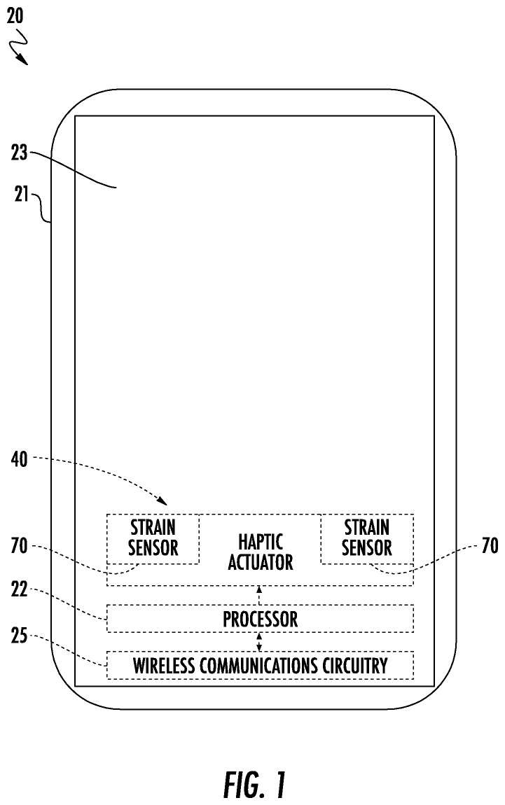

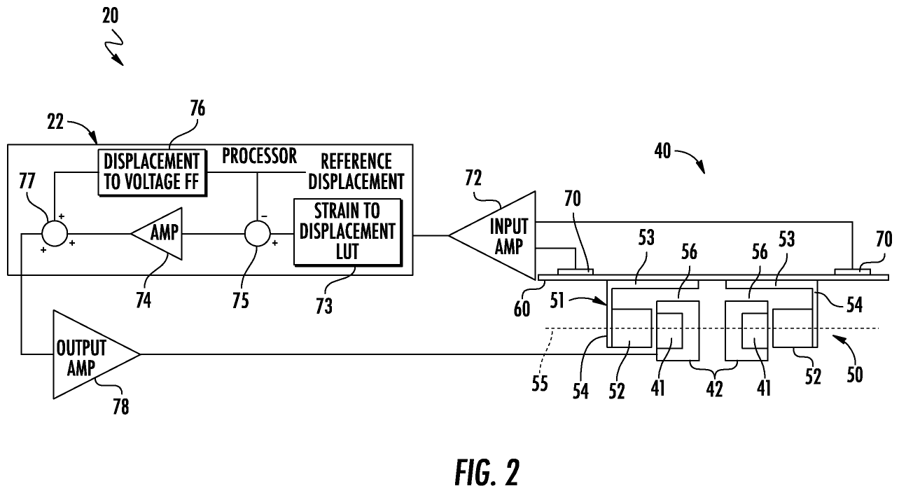

Referring initially to FIGS. 1-2, an electronic device 20 illustratively includes a device housing 21 and a processor 22 carried by the device housing. The electronic device 20 is illustratively a mobile wireless communications device, for example, a cellular telephone or smartphone. The electronic device 20 may be another type of electronic device, for example, a wearable device (e.g., a watch), a tablet computer, a laptop computer, etc.

Wireless communications circuitry 25 (e.g. cellular, WLAN Bluetooth, etc.) is also carried within the device housing 21 and coupled to the processor 22. The wireless communications circuitry 25 cooperates with the processor 22 to perform at least one wireless communications function, for example, for voice and/or data. In some embodiments, the electronic device 20 may not include wireless communications circuitry 25.

A display 23 is also carried by the device housing 21 and is coupled to the processor 22. The display 23 may be, for example, a light emitting diode (LED) display, a liquid crystal display (LCD), or may be another type of display, as will be appreciated by those skilled in the art. The display 23 may be a touch display and may cooperate with the processor 22 to perform a device function in response to operation thereof. For example, a device function may include a powering on or off of the electronic device 20, initiating communication via the wireless communications circuitry 25, and/or performing a menu function.

The electronic device 20 illustratively includes a haptic actuator 40. The haptic actuator 40 is coupled to the processor 22 and provides haptic feedback to the user in the form of relatively long and short vibrations. The vibrations may be indicative of a message received, and the duration and type of the vibration may be indicative of the type of message received. Of course, the vibrations may be indicative of or convey other types of information.

While a processor 22 is described, it should be understood that the processor 22 may include one or more physical processors and/or other circuitry to perform the functions described herein.

The haptic actuator 40 includes a coil 41. The coil 41 is illustratively carried by a coil body 42 that may be secured to a housing or other structure, for example. The haptic actuator 40 may include more than one coil 41.

The haptic actuator 40 also includes a field member 50. The field member 50 includes a frame 51 and a permanent magnet 52 carried by the frame adjacent the coil 41. The frame 51 illustratively has a U-shape having a base 53 and a sidewall 54 extending from the base. The permanent magnet 52 is carried by the sidewall. The field member 50 may include more than one permanent magnet 52. There may be more than one sidewall 54, for example, defining a rectangular shaped haptic actuator 40. Of course, the haptic actuator 40 may be round.

When aligned magnetically (the coil 41 and the permanent magnet 52 as indicated by the dashed line 55), the base 53 of the frame 51 of the field member 50 is spaced from the coil body 42 defining a reluctance path or gap 56. Operation of the coil 41 causes relative movement with the field member 50.

A biasing member 60, for example, in the form of a compliant spring, is carried by the base 53 of the field member frame 51 on a side opposite the sidewall 54. The biasing member 60 may provide biasing to an equilibrium positon or provide biasing during relative movement between the field member 50 and the coil 41.

Strain sensors 70 are carried by the biasing member 60. The strain sensors 70 sense relative movement between the coil 41 and the field member 50. While two strain sensors 70 are illustrated, there may any number of strain sensors.

The strain sensors 70 are coupled to an input amplifier 72, for example, a bridge amplifier. The input amplifier 72 is also coupled to the processor 22. The processor 22 drives the coil 41 based upon the strain sensors 70.

Operations of the processor 22 with respect to closed loop feedback using the strain sensors 70 will now be described. The sensed voltage from the strain sensors 70, via the input amplifier 72 is used to determine a displacement based upon a strain-to-displacement lookup table 73. The displacement is provided to an amplifier 74 along with a reference displacement via a first node 75. A displacement-to-voltage feed forward loop 76 is coupled to the first node 75 and a second node 77. The output of the amplifier 74 is also coupled to the second node 77.

An output amplifier 78 (e.g., a voltage amplifier) is coupled between the processor 22 and the coil 41, and more particularly, to the second node 77. The output provided by the output amplifier 78 to the coil 41 drives the coil with the desired waveform and/or voltage based upon the above described elements.

The electronic device 20 described herein may be implemented as a part of a force feedback system, for example. More particularly, the biasing member 60 may be between the field member 50 and a display layer so that upon relative movement between the coil 41 and the field member 50, there may be deformation of the display layer. Alternatively, deformation of the display layer (e.g., caused by user input thereto) may cause displacement of the field member 50, the displacement of which may be measured by way of the strain sensors 70. If a threshold amount of force is applied, as determined by the processor 22, the processor may operate the haptic actuator 40 to provide haptic feedback, for example, to provide a “click” feedback based upon the input.

A method aspect is directed to a method of driving at least one coil 41 of a haptic actuator 40 that includes a field member 50 including at least one permanent magnet 52, and at least one coil configured to cause relative movement with the field member. The method includes using at least one strain sensor 70 to sense relative movement between the at least one coil 41 and field member 50 and using a processor 22 to drive the at least one coil based upon the at least one strain sensor.

Another aspect is directed to a closed loop system or device 20′ based upon inductive sensing. More particularly, an inductance sensor 80′ is coupled to the coil 41′. The inductance sensor 80′ provides sensed voltage vMon and sensed current iMon from the coil 41′. The sensed voltage vMon and sensed current iMon change based upon the relative movement between the coil 41′ and the field member 50′. The inductance sensor 80′ may be used with the strain sensors 70 described above, for example, to provide more accurate sensed movement between the coil 41′ and the field member 50′. Similarly to the embodiments described above, the processor 22′ drives the coil 41′ based upon the inductance sensor 80′. Further details of the processor 22′ with respect to sensing the relative movement and driving the coil 41′ based upon the inductance sensor 80′ will be described below.

The sensed voltage vMon and sensed current iMon provided from the inductance sensor 80′ are provided as input to an inductance-to-displacement lookup table 73′. In other words, the sensed voltage vMon and sensed current iMon from the inductance sensor 80′ are used to determine a displacement based upon the inductance-to-displacement lookup table 73′. The displacement is provided to an amplifier 74′ along with a reference displacement via a first node 75′. A displacement-to-voltage feed forward loop 76′ is coupled to the first node 75′ and a second node 77′. The output of the amplifier 74′ is also coupled to the second node 77′. A reference tone, or high-frequency tone 79′, as will be appreciated by those skilled in the art, is also provided to the second node 77′. Of course, other frequency tones or waveforms may be provided to the second node 77′. In some embodiments, no tone may be provided to the second node 77′.

An output amplifier 78′ (e.g., a voltage amplifier) is coupled between the processor 22′ and the coil 41′, and more particularly, to the second node 77′. The output of the output amplifier 78′ is also coupled to the input of the inductance-to-displacement lookup table 73′ to provide feedback with respect to the sensed voltage vMon and sensed current iMon. The output provided by the output amplifier 78′ to the coil 41′ drives the coil with the desired waveform and/or voltage based upon the above described elements.

A related method aspect is directed to a method of driving at least one coil 41′ of a haptic actuator 40′ that includes a field member 50′ including at least one permanent magnet 52′, and at least one coil configured to cause relative movement with the field member. The method includes using at least one inductance sensor 80′ to sense relative movement between the at least one coil 41′ and field member 50′ and using a processor 22′ to drive the at least one coil based upon the at least one inductance sensor.

Another aspect is directed to a closed loop system or device 20′ based upon capacitive sensing. More particularly, a capacitive sensor 90″ is coupled to the coil 41″. The capacitive sensor 90″ provides sensed displacement or relative movement between the coil 41″ and the field member 50″ measured by way of capacitance. While two capacitive sensors 90″ are illustrated, there may any number of capacitive sensors.

A change in capacitance corresponds to a change in movement or displacement between the coil 41″ and the field member 50″. The capacitive sensor 90″ may be used with either or both of the inductance sensor 80′ or the strain sensors 70 described above, for example, to provide more accurate sensed movement between the coil 41″ and the field member 50″. Similarly to the embodiments described above, the processor 22″ drives the coil 41″ based upon the capacitance sensor 90″. Further details of the processor 22″ with respect to sensing the relative movement and driving the coil 41′ based upon the capacitive sensor 90″ will be described below.

The capacitive sensors 90″ are coupled to an input amplifier 72″, for example, a bridge amplifier. The input amplifier 72″ is also coupled to the processor 22″. The processor 22″ drives the coil 41″ based upon the capacitive sensors 90″.

Operations of the processor 22″ with respect to closed loop feedback using the capacitive sensors 90″ will now be described. The sensed voltage from the capacitive sensors 90″, via the input amplifier 72″ is used to determine a displacement based upon a capacitance-to-displacement lookup table 73″. The displacement is provided to an amplifier 74″ along with a reference displacement via a first node 75″. A displacement-to-voltage feed forward loop 76″ is coupled to the first node 75″ and a second node 77″. The output of the amplifier 74″ is also coupled to the second node 77″.

An output amplifier 78″ (e.g. a voltage amplifier) is coupled between the processor 22″ and the coil 41″, and more particularly, to the second node 77″. The output provided by the output amplifier 78″ to the coil 41″ drives the coil with the desired waveform and/or voltage based upon the above described elements.

A related method aspect is directed to a method of driving at least one coil 41″ of a haptic actuator 40″ that includes a field member 50″ including at least one permanent magnet 52″, and at least one coil configured to cause relative movement with the field member. The method includes using at least one capacitive sensor 90″ to sense relative movement between the at least one coil 41″ and field member 50″ and using a processor 22″ to drive the at least one coil based upon the at least one capacitive sensor.

Those skilled in the art will appreciate that performance of the haptic actuator 40 is generally dependent on the configuration of the coils, magnets or magnetic components, and the surrounding structure which sets the initial assembly condition and allows the parts to move relative to one another. However, the initial position of the magnets relative to the coil in the actuator affects the magnitude of the output force. To provide a more consistent force or displacement through a range of initial positions, position sensing is desired. In applications when the nominal or equilibrium position of the actuator may shift over time, it may be possible to maintain consistent actuator output through calibration of position using both strain sensing (force) and inductive sensing. Thus, the electronic device 20 may be particularly advantageous for maintaining consistent force and displacement output over lifetime variations and over variations in initial load (deformation) applied to the top spring or biasing member of the actuator.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. An electronic device comprising:
a haptic actuator comprising a field member comprising at least one permanent magnet, and at least one coil configured to cause relative movement with the field member;
at least one inductance sensor configured to sense relative movement between the at least one coil and field member; and
a processor configured to drive the at least one coil based upon the at least one inductance sensor.

2. The electronic device of claim 1 wherein the processor is configured to drive the at least one coil based upon a sensed voltage and a sensed current of the at least one coil.

3. The electronic device of claim 1 wherein the processor is configured to drive the at least one coil based upon an inductance-to-displacement look-up table.

4. The electronic device of claim 1 wherein the processor is configured to drive the at least one coil based upon a displacement-to-voltage feedforward loop.

5. The electronic device of claim 1 wherein the processor is configured to drive the at least one coil based upon a reference displacement.

6. The electronic device of claim 1 wherein the processor is configured to drive the at least one coil based upon a reference tone.

7. The electronic device of claim 1 further comprising an output amplifier coupled between the processor and the at least one coil.

8. An electronic device comprising:
a housing;
wireless communications circuitry carried by the housing;
a haptic actuator carried by the housing and comprising a field member comprising at least one permanent magnet, and at least one coil configured to cause relative movement with the field member;
at least one inductance sensor configured to sense relative movement between the at least one coil and field member; and
a processor configured to perform at least one wireless communications function and drive the at least one coil based upon the at least one inductance sensor.

9. The electronic device of claim 8 wherein the processor is configured to drive the at least one coil based upon a sensed voltage and a sensed current of the at least one coil.

10. The electronic device of claim 8 wherein the processor is configured to drive the at least one coil based upon an inductance-to-displacement look-up table.

11. The electronic device of claim 8 wherein the processor is configured to drive the at least one coil based upon a displacement-to-voltage feedforward loop.

12. The electronic device of claim 8 wherein the processor is configured to drive the at least one coil based upon a reference displacement.

13. The electronic device of claim 8 wherein the processor is configured to drive the at least one coil based upon a reference tone.

14. The electronic device of claim 8 further comprising an output amplifier coupled between the processor and the at least one coil.

15. A method of driving at least one coil of a haptic actuator comprising a field member comprising at least one permanent magnet, and at least one coil configured to cause relative movement with the field member, the method comprising:
using at least one inductance sensor to sense relative movement between the at least one coil and field member; and
using a processor to drive the at least one coil based upon the at least one inductance sensor.

16. The method of claim 15 wherein using the processor comprises using the processor to drive the at least one coil based upon a sensed voltage and a sensed current of the at least one coil.

17. The method of claim 15 wherein using the processor comprises using the processor to drive the at least one coil based upon an inductance-to-displacement look-up table.

18. The method of claim 15 wherein using the processor comprises using the processor to drive the at least one coil based upon a displacement-to-voltage feedforward loop.

19. The method of claim 15 wherein using the processor comprises using the processor to drive the at least one coil based upon a reference displacement.

20. The method of claim 15 wherein using the processor comprises using the processor to drive the at least one coil based upon a reference tone.

21. An electronic device comprising:
a haptic actuator comprising a field member comprising at least one permanent magnet, and at least one coil configured to cause relative movement with the field member;
at least one capacitive sensor configured to sense relative movement between the at least one coil and field member; and
a processor configured to drive the at least one coil based upon the at least one capacitive sensor.

22. The electronic device of claim 21 further comprising an input amplifier coupled between the at least one capacitive sensor and the processor.

23. The electronic device of claim 21 wherein the processor is configured to drive the at least one coil based upon a capacitance-to-displacement look-up table.

24. The electronic device of claim 21 wherein the processor is configured to drive the at least one coil based upon a displacement-to-voltage feedforward loop.

25. The electronic device of claim 21 wherein the processor is configured to drive the at least one coil based upon a reference displacement.

26. The electronic device of claim 21 further comprising an output amplifier coupled between the processor and the at least one coil.

27. The electronic device of claim 21 wherein the at least one capacitive sensor comprises a plurality of capacitive sensors.
